(19) United States
(12) Patent Application Publication
(10) Pub. No.: US 2008/0078709 A1
(43) Pub. Date: Apr. 3, 2008

(54) CONCRETE MIXER DRIVE

(76) Inventor: Kenneth W. Craig, Markle, IN (US)

Correspondence Address: TAYLOR & AUST, P.C., P.O. Box 560, 142. S Main Street, Avilla, IN, 46710, US

(21) Appl. No.: 11/860,716

(22) Filed: Sep. 25, 2007

Related U.S. Application Data
(60) Provisional application No. 60/848,096, filed on Sep. 29, 2006.

(51) Int. Cl. F01M 11/00; B01D 35/00; B01D 35/14

(52) U.S. Cl. 210/87; 210/120; 210/167.08

(57) ABSTRACT

A concrete mixing truck including an engine, a frame supporting the engine, and a power transfer system receiving mechanical power from the engine. The power transfer system includes a housing, a power input shaft, a plurality of power output shafts, a plurality of gears and a power driven filter system. The housing has a lower portion wherein a lubricant pools in a lubricant pool. The power input shaft extends from the housing. The plurality of power output shafts each are driven by the power input shaft. The plurality of gears are associated with the power input shaft, and the plurality of power output shafts. At least one of the gears sling the lubricant from the lubricant pool thereby lubricating the plurality of gears and at least a portion of the shafts. The power driven filter system is fluidly connected to the lubricant pool. The power driven system pumps the lubricant from the lubricant pool through a filter to produce filtered lubricant that is returned to the housing.

### CROSS REFERENCE TO RELATED APPLICATIONS

This is a non-provisional application based upon U.S. provisional patent application Ser. No. 60/848,096, entitled “POWER TRANSFER DEVICE”, filed Sep. 29, 2006, which is incorporated herein by reference.

### BACKGROUND OF THE INVENTION

1. Field of the Invention

The present invention relates to a concrete mixer truck, and, more particularly, to a concrete mixer drive for a concrete mixer truck.

2. Description of the Related Art

Concrete products have been utilized for thousands of years in various forms. During the Roman Empire concrete was made from quicklime, ash and an aggregate made from pumas, which is very similar to modern day Portland cement concrete. In 1756 British Engineer John Smeaton rediscovered the use of concrete by using hydraulic lime and pebbles or powdered brick as aggregate. Portland cement was first used in concrete in the early 1840's.

The composition of concrete is determined initially during mixing, which may then be altered prior to pouring the concrete by way of further mixing of the concrete by the concrete mixer truck. About six billion cubic meters of concrete are made each year, which equals approximately one cubic meter for every person on earth. The concrete industry in the U.S. alone is approximately a thirty-five billion dollar industry and employs more than two million workers.

Concrete trucks, or more accurately concrete transport trucks provide in-transit mixing of concrete from the factory/plant to the construction site. Generally the material has already been mixed prior to loading the truck and the truck maintains the concrete in a liquid state by way of continuous agitation by the turning of the drum until delivery of the concrete at the worksite. Concrete trucks primarily exist now in the form of a front dump variety as illustrated in FIG. 1. Although some areas still utilize rear discharge trucks.

Concrete trucks include a drive system for the driving of the various axles and for the driving of the drum by the engine. Multiple axles are utilized to support the great weight of the concrete and the truck at worksites, which may have relatively soft ground upon which the truck much traverse. Mixer drive units often encounter high moisture conditions and are often prone to failure.

What is needed in the art is a reliable long lasting drive unit for use in concrete mixer trucks.

### SUMMARY OF THE INVENTION

The present invention provides a concrete mixing truck including an engine, a frame supporting the engine, and a power transfer system receiving mechanical power from the engine. The power transfer system includes a housing, a power input shaft, a plurality of power output shafts, a plurality of gears and a power driven filter system. The housing has a lower portion wherein a lubricant pools in a lubricant pool. The power input shaft extends from the housing. The plurality of power output shafts each are driven by the power input shaft. The plurality of gears are associated with the power input shaft, and the plurality of power output shafts. At least one of the gears sling the lubricant from the lubricant pool thereby lubricating the plurality of gears and at least a portion of the shafts. The power driven filter system is fluidly connected to the lubricant pool. The power driven system pumps the lubricant from the lubricant pool through a filter to produce filtered lubricant that is returned to the housing.

An advantage of the present invention is that the lubricant in the power drive system is filtered.

Another advantage of the present invention is that in the event of the failure of the filter system, the moving parts in the housing are still completely lubricated, the lubrication being accomplished by the oil slinging of the gear running in the lubricant pool.

Yet still another advantage of the present invention is that the housing is vented at two places and that are joined in order to equalize the pressure therebetween.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical side view of a concrete mixing truck utilizing an embodiment of the power transfer system of the present invention;

FIG. 2 is a perspective view of the power transfer system utilized in the concrete mixing truck of FIG. 1;

FIG. 3 is another perspective view of the power transfer system of FIG. 2 utilized in the concrete mixing truck of FIG. 1; and

FIG. 4 is a partially cross-sectioned view of the power transfer case of FIGS. 2 and 3 taken along 4-4.

Corresponding reference characters indicate corresponding parts throughout the several views. The exemplifications set out herein illustrate one embodiment of the invention, in one form, and such exemplifications are not to be construed as limiting the scope of the invention in any manner.

### DETAILED DESCRIPTION OF THE INVENTION

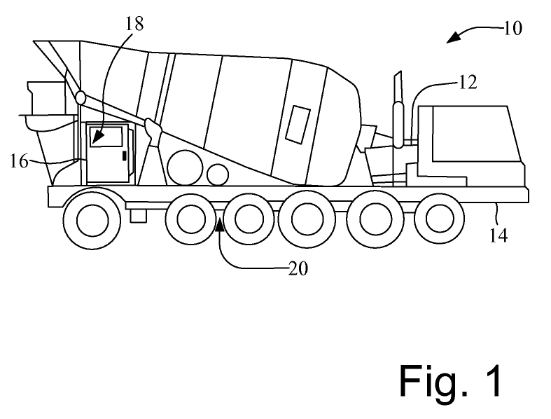

Referring now to the drawings, and more particularly to FIG. 1, there is shown a concrete mixing truck 10 having an engine 12, a frame 14, a cab 16 with display/controls 18 therein. A power transfer system 20 is connected to frame 14 and is driven by engine 12. Power transfer system 20 transfers power from the engine for the driving of the concrete drum as well as to other mechanisms in concrete truck 10.

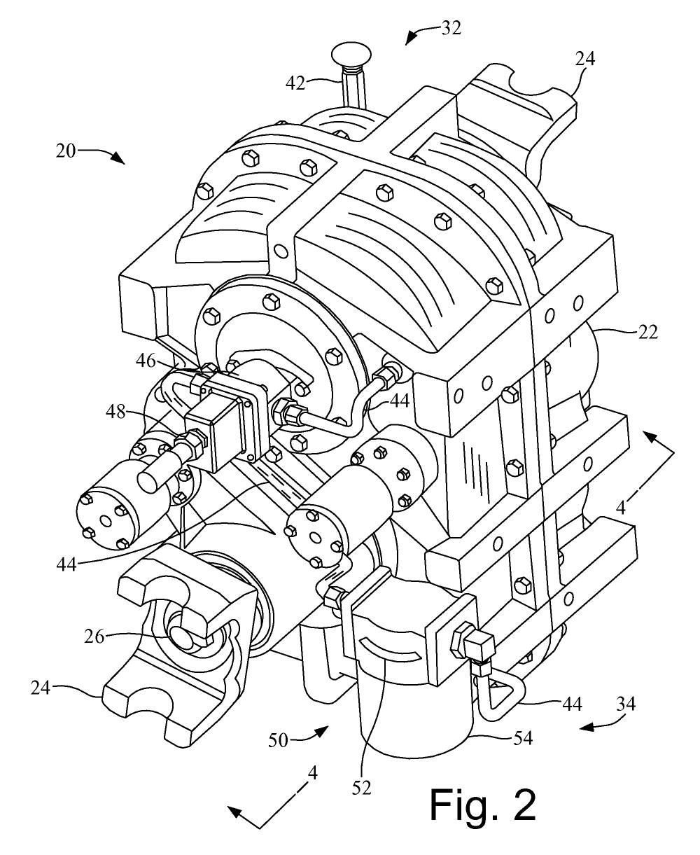

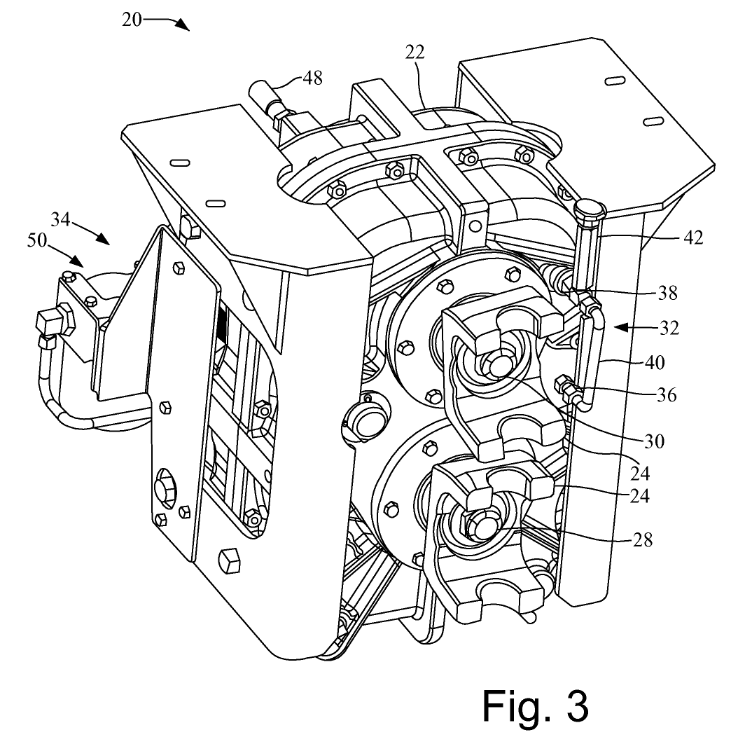

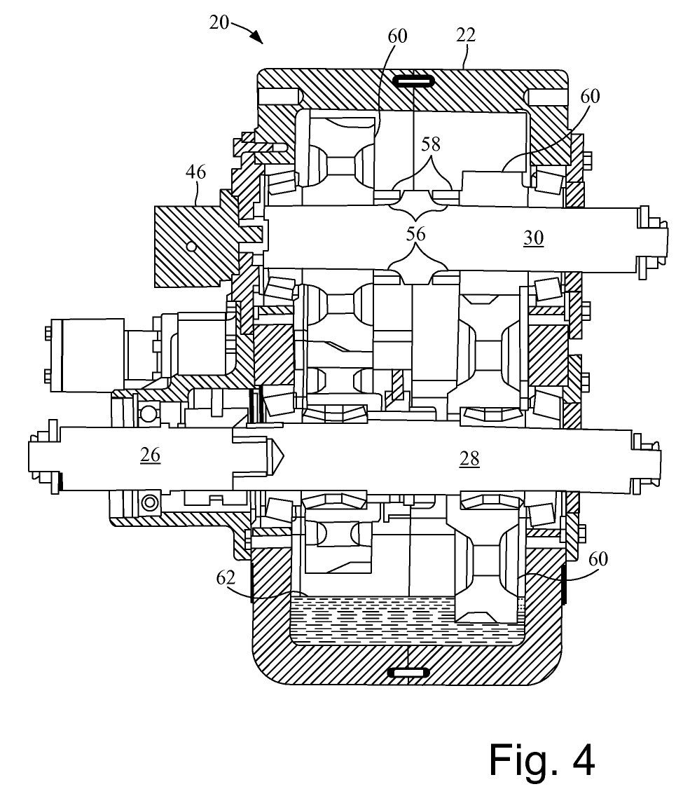

Now, additionally referring to FIGS. 2-4 there is illustrated more of the details of power transfer system 20, which is also known as a mixer drive 20 or a transfer case 20. Mixer drive 20 includes a housing 22, yokes 24, shafts 26, 28 and 30, a venting system 32 and a filter system 34. Housing 22 may be a split case that is held together with bolts and is aligned by pins that are inserted or extend from a portion of housing 22. Housing 22 may be a cast metal or machined metal casing for the positioning of the components therein. Shafts 26, 28 and 30 extend from a portion of housing 22 and have yokes 24 appropriately connected thereto. Yokes 24 interface with universal joints from drive shafts for transferring of power to and/or from mixer drive 20.

Venting system 32 includes a coupling 36, a coupling 38, a tube 40 and a vent 42. Coupling 36 is coupled to an opening in housing 22. In a like manner coupling 38 is coupled to another opening in housing 22 at a different position along housing 22. The positioning of two couplings at different locations allow for the distribution of any localized unequalized pressure in housing 22 and advantageously helps prevent the discharging of the lubricant from housing 22, which can happen if housing 22 is only vented at one position. Further, by positioning vent 42 in a substantially vertical manner and having it extend above the top of case 22 with an opening at the top thereof, reduces the likelihood of ingress of water into housing 22. Housings that are vented close to the housing often ingress water into the case leading to premature failure of the drive box.

Filter system 34 includes tubes 44, a pump 46, a pump sensor 48, a filter assembly 50 having a filter sensor 52 and a filter element 54. Tubes 44 connect to a lower portion of housing 22 in order to retrieve lubricant from the bottom portion of the case, which is then routed through filter element 54 and pump 46 before being returned into housing 22. Pump 46 is driven from a shaft that is otherwise utilized for conveying power to or from mixer drive 20. Pump sensor 48 detects the movement of the shaft that is driving pump 46. A signal from sensor 48 may be utilized by controls 18 to indicate the operation of mixer drive 20. Filter sensor 52 detects the presence of water in filter element 54 and/or the fluid flow through filter assembly 50. The combination of the flow of lubricant through filter assembly 50 coupled with the operation of pump 46 as sensed by pump sensor 48 can, in combination, be utilized by display/controls 18 to evaluate the functioning of powered filter system 34. Advantageously if filter system 34 ceases to function the lubrication continues within mixer drive 20, since the lubrication is by way of a oil sling system due to the interaction of at least one gear with the lubricant in the lubricant pool. This allows the concrete delivery to continue even if the filtering system has failed so that the concrete can be discharged at the site and then maintenance can be performed on filter system 34 at a later time.

Shaft 30 includes curved annular areas 56, which are curved to engage and center spacing rings 58 that are located between the raised portion of shaft 30 and a gear 60. Curved annular area 56 is shaped so that as spacing rings 58 are positioned on shaft 30 the spacing rings 58 are centered about shaft 30 and are held in position by the relative position of a gear 60. Lubricant in the bottom of housing 22 has a lubricant level 62 that is above the lower portions of at least one gear 60 allowing the sling lubrication system to function within housing 22. The lubricant can become contaminated with water, which is removed by a water separating provision of filter element 54.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A concrete mixing truck, comprising:
an engine;
a frame supporting said engine;
a power transfer system receiving mechanical power from said engine, said power transfer system including:
a housing having a lower portion wherein a lubricant pools in a lubricant pool;
a power input shaft extending from said housing;
a plurality of power output shafts each being driven by said power input shaft;
a plurality of gears associated with at least one of said power input shaft and said plurality of power output shafts, at least one of said plurality of gears slinging said lubricant from said lubricant pool to thereby lubricate said plurality of gears, at least a portion of said input shaft and a portion of said plurality of output shafts; and
a power driven filter system fluidly connected to said lubricant pool, said power driven filter system pumping said lubricant from said lubricant pool through a filter to produce filtered lubricant that is returned to said housing.

2. The concrete mixing truck of claim 1, wherein said power driven filter system includes a filtering element and a water separating provision.

3. The concrete mixing truck of claim 2, wherein said power driven filter system includes a sensor for the detection of at least one of a predetermined amount of water and a reduced flow through said power driven filter system.

4. The concrete mixing truck of claim 3, wherein said sensor provides a signal to a display indicating a condition of said filtering element.

5. The concrete mixing truck of claim 1, wherein said power transfer system includes a venting system having a plurality of fluid couplings to said housing.

6. The concrete mixing truck of claim 5, wherein said plurality of fluid couplings includes a first fluid coupling and a second fluid coupling, said first fluid coupling being coupled to said housing at a higher elevation than said second fluid coupling.

7. The concrete mixing truck of claim 5, wherein said venting system includes a substantially vertical vent that is fluidly coupled to each of said plurality of fluid couplings.

8. The concrete mixing truck of claim 7, wherein said substantially vertical vent has an opening that is above said housing.

9. The concrete mixing truck of claim 1, wherein said power transfer system includes at least one spacing ring, at least one of said power input shaft and said plurality of power output shafts being a first shaft, said first shaft including at least one annular area that is curved in cross-section, said at least one spacing ring being in contact with said annular area and being radially centered about said first shaft.

10. The concrete mixing truck of claim 9, wherein said at least one annular area includes a first annular area and a second annular area of said first shaft, said at least one spacing ring including a first spacing ring and a second spacing ring, said first spacing ring being in contact with said first annular area and one of said plurality of gears, said second spacing ring being in contact with said second annular area and an other one of said plurality of gears, said first spacing ring and said second spacing ring being centered about said first shaft.

11. A power transfer system, comprising:
a housing having a lower portion wherein a lubricant pools into a lubricant pool;
a power input shaft extending from said housing;
a plurality of power output shafts each being driven by said power input shaft;
a plurality of gears associated with at least one of said power input shaft and said plurality of power output shafts, at least one of said plurality of gears slinging said lubricant from said lubricant pool to thereby lubricate said plurality of gears, at least a portion of said input shaft and a portion of said plurality of output shafts; and
a power driven filter system fluidly connected to said lubricant pool, said power driven filter system pumping said lubricant from said lubricant pool through a filter to produce filtered lubricant that is returned to said housing.

12. The power transfer system of claim 11, further comprising a filtering element with a water separating provision.

13. The power transfer system of claim 12, wherein said power driven filter system includes a sensor for the detection of at least one of a predetermined amount of water and a reduced flow of said lubricant through said power driven filter system.

14. The power transfer system of claim 13, wherein said sensor provides a signal to a display indicating a condition of said filtering element.

15. The power transfer system of claim 11, wherein said power transfer system includes a venting system having a plurality of fluid couplings to said housing.

16. The power transfer system of claim 15, wherein said plurality of fluid couplings includes a first fluid coupling and a second fluid coupling, said first fluid coupling being coupled to said housing at a higher elevation than said second fluid coupling.

17. The power transfer system of claim 15, wherein said venting system includes a substantially vertical vent that is fluidly coupled to each of said plurality of fluid couplings.

18. The power transfer system of claim 17, wherein said substantially vertical vent has an opening that is above said housing.

19. The power transfer system of claim 11, wherein said power transfer system includes at least one spacing ring, at least one of said power input shaft and said plurality of power output shafts being a first shaft, said first shaft including at least one annular area that is curved in cross-section, said at least one spacing ring being in contact with said annular area and being radially centered about said first shaft.

20. The power transfer system of claim 19, wherein said at least one annular area includes a first annular area and a second annular area of said first shaft, said at least one spacing ring including a first spacing ring and a second spacing ring, said first spacing ring being in contact with said first annular area and one of said plurality of gears, said second spacing ring being in contact with said second annular area and an other one of said plurality of gears, said first spacing ring and said second spacing ring being centered about said first shaft.
